(19) United States
(12) Patent Application Publication
(10) Pub. No.: US 2010/0176761 A1
(43) Pub. Date: Jul. 15, 2010

(54) Battery Charging Device

(75) Inventors: Toshiyuki Suzuki, Ibaraki (JP); Hiroyuki Hanawa, Ibaraki (JP); Toshio Mizoguchi, Ibaraki (JP)

Correspondence Address: KIMBLE INTELLECTUAL PROPERTY LAW, PLLC, 1701 PENNSYLVANIA AVE., NW, SUITE 300, WASHINGTON, DC, 20006, US

(73) Assignee: HITACHI KOKI CO., LTD., Tokyo (JP)

(21) Appl. No.: 12/440,465

(22) PCT Filed: Sep. 7, 2007
(86) PCT No.: PCT/JP2007/067894

§ 371 Date: Mar. 7, 2009

(30) Foreign Application Priority Data
Sep. 7, 2006 (JP) 2006-243340

(51) Int. Cl. H02J 7/00

(52) U.S. Cl. 320/107

(57) ABSTRACT

The peripheral edge of the upper face 31A of a plate-shaped portion 31 of a holding member 30 confronts a terminal exposing through hole, cast through holes, and the inner periphery of an upper housing 10, i.e., a portion defining the terminal exposing through hole and the cast through holes. The upper face 31A of the plate-shaped portion 31 defines a passage for passing rain water having flown from the terminal exposing through hole and the cast through holes into a housing space 1a. The lower end of the passage forms grooves 30a and communicates with stepped through holes 12a formed in the upper housing 10, so that the rainwater is released from the stepped through holes 12a to the outside of the upper housing 10.

### TECHNICAL FIELD

The present invention relates to a battery charging device for charging a rechargeable battery, and to a battery charging device including an upper housing and a lower housing.

### BACKGROUND ART

In the related art, there is known a battery charging device including an upper housing and a lower housing, by which a housing space is defined.

It is disclosed by, for example JP-A-8-287960, that a battery charging device includes a lower housing and an upper housing, by which a housing space is defined, charging/discharging terminals, a circuit board and so on are housed in the housing space. The upper housing is equipped with an opening, into which the charging/discharging terminals of the rechargeable battery. A drain hole is formed in such a portion of the lower housing as confronts the opening, into which the charging/discharging terminals are inserted. When the charging operation is performed outdoors, rain water enters the housing space from the clearance between the battery and the upper housing, but is released through the drain hole to the lower side or the outside of an outer housing.

### DISCLOSURE OF THE INVENTION

In the battery charging device of the related art described above, however, the drain hole is formed in a portion of the outer housing, i.e., below the opening, into which the charging/discharging terminals of the battery are inserted. This constitution forms a rain water passage in the portion of the housing space in a direction to join the opening the upper housing and the drain hole of the lower housing. This constitution has made it impossible to arrange a substrate mounting electronic parts, in the portion of that housing space.

Therefore, the invention has an object to provide a battery charging device, which can arrange a circuit board in a portion of a housing space in a direction joining an upper housing and a lower housing, that is, a portion confronting an opening for exposing a charging/discharging terminals and which can exploit the housing space effectively.

In order to the aforementioned object, according to the invention, there is provided a battery charging device comprising: a lower housing; and an upper housing defining a housing space together with the lower housing and including at least one inlet side opening having a through hole formed to provide the communication between the housing space and the atmosphere. The housing space is equipped with an outlet passage forming member for defining a passage to guide the water having flown from the inlet side opening into the housing space by attaching the outlet passage forming member to the upper housing.

Here, it is preferred that the upper housing includes at least one outlet side opening having a through hole formed to provide the communication between the housing space and the atmosphere, and that the passage communicates with the outlet side opening.

It is also preferred that the passage is sloped downward from the inlet side opening toward the outlet side opening.

Alternatively, it is preferred that the lower housing has its lower portion formed with a lower through hole for providing the communication between the housing space and the atmosphere, and that the passage is constituted to guide the water having flown from the inlet side opening into the housing space, into the lower through hole.

It is further preferred that the lower housing has a lower housing passage, one end of which is formed by the lower through hole, and that the passage is constituted to guide the water having flown from the inlet side opening into the housing space, to the other end of the lower housing passage.

It is further preferred that the passage is sloped downward from the inlet side opening toward the other end of the lower housing passage.

It is further preferred that the outlet passage forming member includes a holding member for holding a terminal block.

It is further preferred that the passage is formed along the upper housing. It is further preferred that the inlet side opening is an opening for exposing charging terminals to the outside of the housing.

It is further preferred that the upper housing includes slide rails for sliding a battery in the upper housing to guide the battery charging terminals of the battery in a direction to the charging terminals, so that the battery charging terminals may contact with the charging terminals, and that the through hole of the inlet side opening is cast holes for forming the slide rails on the upper housing when the upper housing is formed by a mold.

According to an aspect of the invention, the inlet side opening is formed in the upper housing, and the housing space is equipped with the outlet passage forming member for defining a passage by attaching the outlet passage forming member to the upper housing. As a result, the water having flown from the inlet side opening into the housing space can flow in the passage of the outlet passage forming member.

It is, therefore, unnecessary to form the passage for the rain water in the portion of the housing space in the direction to join the upper housing and the lower housing, that is, in the portion confronting the inlet side opening, but the circuit board and so on can be arranged in that portion so that the housing space can be effectively exploited. Moreover, the circuit board arranged in the housing space can be waterproofed to make the shielding portion the minimum necessary.

According to another aspect of the invention, the upper housing includes at least one outlet side opening having the through hole formed to provide the communication between the housing space and the atmosphere, and the passage communicates with the outlet side opening. As a result, the water having flown from the inlet side opening into the housing space can be released through the passage of the outlet passage forming member from the outlet side opening to the outside of the housing space.

According to another aspect of the invention, the passage is sloped downward from the inlet side opening toward the outlet side opening. As a result, the rain water having flown from the inlet side opening into the housing space can naturally flow to the outlet side opening.

According to another aspect of the invention, the lower housing has its lower portion formed with the lower through hole for providing the communication between the housing space and the atmosphere, and the passage is constituted to guide the water having flown from the inlet side opening into the housing space, into the lower through hole. As a result, the water having flown from the inlet side opening into the housing space can be released through the passage of the outlet passage forming member from the lower through hole to the outside of the housing space.

According to another aspect of the invention, the lower housing has the lower housing passage, one end of which is formed by the lower through hole, and the passage is constituted to guide the water having flown from the inlet side opening into the housing space, to the other end of the lower housing passage. As a result, the water having flown from the inlet side opening into the housing space can be released through the passage of the outlet passage forming member and the lower housing passage from the lower through hole to the outside of the housing space.

According to another aspect of the invention, the passage is sloped downward from the inlet side opening toward the other end of the lower housing passage. As a result, the rainwater having flown from the inlet side opening into the housing space can naturally flow to the other end of the lower housing passage.

According to another aspect of the invention, the outlet passage forming member includes a holding member for holding a terminal block. As a result, the member for supporting the terminal block in the housing space need not be separately provided so that the constitution of the battery charging device can be simplified.

According to another aspect of the invention, the passage is formed along the upper housing. As a result, the passage need not be formed in the portion of the housing space, i.e., in the portion defined by the lower housing, so that the corresponding space can be effectively exploited.

According to another aspect of the invention, the inlet side opening is the opening for exposing charging terminals to the outside of the housing. The charging terminals can be exposed through that portion to the outside of the outer housing.

According to another aspect of the invention, the upper housing includes slide rails for sliding the battery in the upper housing to guide the battery charging terminals of the battery in a direction to the charging terminals, so that the battery charging terminals may contact with the charging terminals, and the through hole of the inlet side opening is cast holes for forming the slide rails on the upper housing when the upper housing is formed by the mold. As a result, the constitution of the mold for molding the upper housing can be simplified. This simplification can reduce the cost for molding the upper housing.

### BRIEF DESCRIPTION OF THE DRAWINGS

FIG. 1A is a front perspective view showing a battery charging device according to the mode of embodiment of the invention.

FIG. 1B is a rear perspective view showing the battery charging device according to the mode of embodiment of the invention.

FIG. 2 is an exploded perspective view showing an upper housing, a lower housing and a holding member of the battery charging device according to the mode of embodiment of the invention.

FIG. 3 is a sectional view showing the upper housing, the lower housing and the holding member of the battery charging device according to the mode of embodiment of the invention.

FIG. 4 is a perspective view showing the holding member of the battery charging device according to the mode of embodiment of the invention.

FIG. 5 is a sectional view showing modifications of the upper housing, the lower housing and the holding member of the battery charging device according to the mode of embodiment of the invention.

### BEST MODE FOR CARRYING OUT THE INVENTION

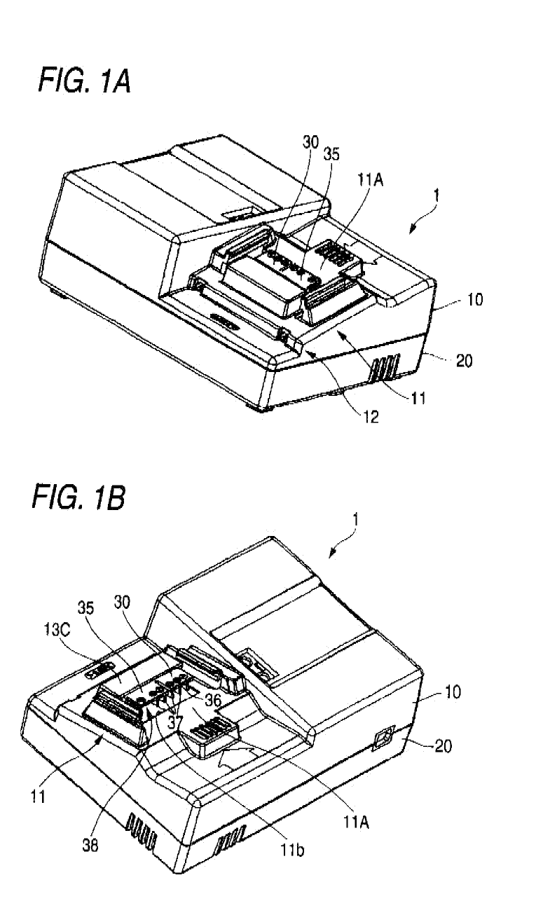

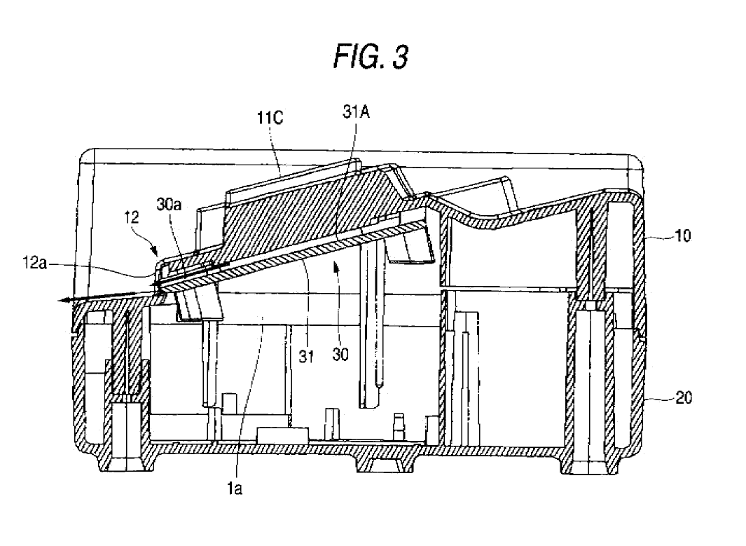

A charging device according to a mode of embodiment of the invention is described with reference to FIG. 1A to FIG. 4. As shown in FIGS. 1A, 1B, a battery charging device 1 includes an upper housing 10 and a lower housing 20. These upper housing 10 and lower housing 20 engage with each other to define a housing space 1a (FIG. 3).

The lower housing 20 is formed generally into a box shape having a bottom and an upper face wholly opened. The upper housing 10 is formed to cover the opening of the lower housing 20. In the generally right side of FIG. 1A in the longitudinal direction of the generally rectangular opening of the lower housing 20, there is mounted a battery setting unit 11 for setting the battery when the battery is to be charged.

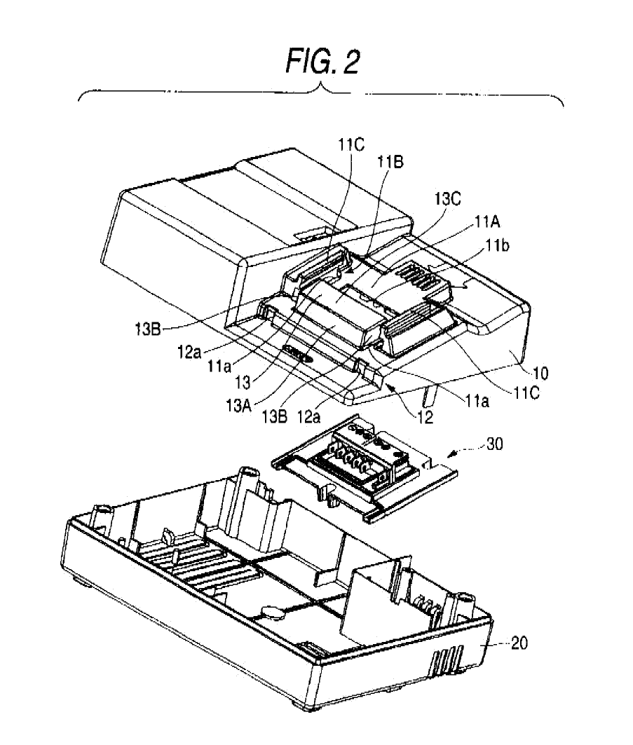

The battery setting unit 11 has a sloped face 11A, which is sloped downward toward the lower housing 20 in a direction from one to the other of the longer side of the generally rectangular opening of the lower housing 20, that is, from the righthand upper side of FIG. 2 to the lefthand lower side. The sloped face 11A extends so far from the righthand upper direction of FIG. 2 toward the lefthand lower direction to a predetermined position as is connected at its extending end to a stepped portion 12 downward to the lower housing 20. In the side walls forming that stepped portion 12, as shown in FIG. 2 and so on, there are formed two stepped through holes 12a, which provide communication between the housing space 1a (FIG. 3) and the upper housing 10. The stepped through holes 12a correspond to outlet-side openings.

On the other hand, the sloped face 11A is formed with cast holes 11B. As shown in FIG. 2, the cast holes 11B are equipped with slide rails 11C, which are molded integrally with the upper housing 10 extending in; parallel with the sloped face 11A in a direction along the inclination of the sloped face 11A. The slide rails 11C are constituted to slide the (not-shown) battery rails on the slide rails 11C thereby to guide the charging/discharging terminals of the not-shown battery toward charging/discharging terminals 36, so that the charging/discharging terminals of the battery may be brought into contact and electrically connected with the charging/discharging terminals 36.

In positions of the sloped face 11A confronting the slide rails 11C, there are formed cast through holes 11a, which extend in a direction joining the top and bottom of the slope of the sloped face 11A along the slide rails 11C. The cast through holes 11a are formed by the not-shown cast pins, which are formed on the mold to form the slide rails 11C when the upper housing 10 is molded by the not-shown mold. Moreover, the cast holes 11B correspond to inlet-side openings.

When the upper housing 10 is formed by the not-shown mold, the cast through holes 11a for forming the slide rails 11C are formed in the upper housing 10, so that the constitution of the not-shown mold for molding the upper housing 10 can be simplified. This simplification can reduce the cost for molding the upper housing 10.

In the sloped face 11A, on the other hand, there is formed a terminal exposing through hole 11b. This terminal exposing through hole 11b extends in the longitudinal direction of the upper housing 10, i.e., in the direction to join the lefthand upper portion and the righthand lower portion of FIG. 2 so that it has a generally rectangular opening. Through the terminal exposing through hole 11b, as shown in FIGS. 1A, 1B, both a portion of a holding member 30 for holding the later-described terminal block 38 and a portion of the terminal block 38 are protruded from the housing space 1a to the outer side of the upper housing 10.

At such a position of the opening of the terminal exposing through hole 11b as corresponds to the lower portion of the slope of the sloped face 11A, as shown in FIG. 2, there is formed a protecting portion 13, which covers and protects both a portion of the later-described holding member 30 protruding from the terminal exposing through hole 11b to the outside of the upper housing 10 and a portion of the terminal block 38. The protecting portion 13 is constituted to include: a first side wall 13A erected from one longer side of the terminal exposing through hole 11b of the generally rectangular shape, i.e., from the longer side positioned below the slope of the sloped face 11A; a pair of second side wall portions 13B and 13B erected from the paired shorter side portions of the terminal exposing through hole 11b of the generally rectangular shape, i.e., from the portions directed from one longer side toward the other of the terminal exposing through hole 11b of the generally rectangular shape to a predetermined position; and a ceiling wall 13C connected to the extending end of the first side wall portion 13A and the extension ends of the paired second side wall portions 13B and 13B. The protecting portion 13 covers a portion of the terminal exposing through hole 11b, i.e., the portion corresponding to the lower portion of the slope of the sloped face 11A. The portion of the sloped face 11A defining the terminal exposing through hole 11b corresponds to the inlet-side opening portion.

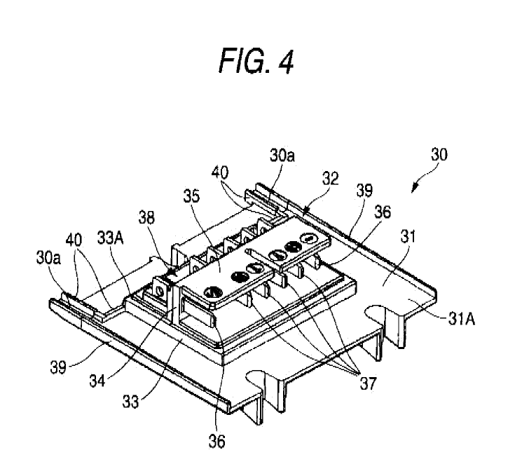

The housing space 1a is equipped with the holding member 30 and the not-shown circuit board. The holding member 30 is attached to the inner periphery of the upper housing 10 by means of the not-shown screws. The holding member 30 serves as an outlet passage forming member. As shown in FIG. 4, the holding member 30 includes a plate-shaped portion 31 of a generally rectangular shape, and a terminal holding portion 32 erected from the plate-shaped portion 31. The terminal holding portion 32 includes: a base portion 33 higher than the upper face 31A of the plate-shaped portion 31; a vertical wall 34 extending vertically from the upper face 31 of the base portion; and a ceiling wall 35 extending in parallel with the upper face 31A of the plate-shaped portion 31 from the extending end of the vertical wall 34. This vertical wall 34 holds the terminal block 38 having the charging/discharging terminals 36 and signal terminals 37. The charging/discharging terminals 36 correspond to charging terminals.

The charging/discharging terminals 36 and the signal terminals 37 are individually formed into general plate shapes, and are extended in the direction vertical to and in parallel with the upper face 31A of the plate-shaped portion 31, and in the extending direction of the ceiling wall 35 and in the opposite direction, as shown in FIG. 4. Those portions, as extend from the vertical wall 34 in the extending direction of the ceiling wall 35, of the charging/discharging terminals 36 and the signal terminals 37 can be electrically connected in contact with the charging/discharging terminals of the chargeable battery. Moreover, the charging/discharging terminals 36 and the signal terminals 37 are individually connected electrically with the not-shown circuit board.

The peripheral edge portion of the upper face 31A of the plate-shaped portion 31 confronts the terminal exposing through hole 11b, the cast through holes 11a, and a part of the inner periphery of the upper housing where the terminal exposing through hole 11b and the cast through holes 11a define. The paired short sides of the plate-shaped portion 31 of a generally rectangular shape are equipped with edge walls 39, which are erected individually along the paired short sides vertically of the upper face 31A of the plate-shaped portion 31 and in the extending direction of the vertical walls 34. Moreover, inner walls 40 are erected from the edge portions 33A of the base portion 33 corresponding to the lower portion of the slope of the sloped face 11A and toward the edge walls 39 to predetermined positions. The inner walls extend in parallel with the edge walls 39 from the predetermined positions so that the edge walls 39 and the inner walls 40 define grooves 30a. The terminal ends of the grooves 30a communication with the stepped through holes 12a, as shown in FIG. 3. As a result, a portion of the housing space 1a, that is, the upper face 31A and the side walls 39 of the plate-shaped portion 31, and the side walls and the inner walls, of the base portion 33 constitute a flow passage for guiding the rain water, which has flown from the outside of the upper housing 10 through the terminal exposing through hole 11b or the cast through holes 11a into the housing space 1a, into the stepped through holes 12a.

The sloped face 11A is sloped from the righthand upper portion to the lefthand lower portion of FIG. 2, as has been described hereinbefore, downward in a direction approach the lower housing 20 so that the flow passage slopes in the same direction. Rainwater flowing into the housing space 1a from an opening of inflow side can be self-flowing to an opening of outflow side. Moreover, the passage is formed over the plate-shaped portion 31 confronting the upper housing 10, so that it is formed along the upper housing 10. Moreover, the passage is formed at such a portion in the housing space 1a as is defined by the upper housing 10. As a result, the passage need not be formed in the portion of the housing space 1a, i.e., in the portion defined by the lower housing 20, so that the corresponding space can be effectively exploited.

The edge portion of the plate-shaped portion 31, i.e., the portion other than the portion in the grooves 30a is equipped with the not-shown shield portion made of urethane. More specifically, the shield portion is formed exclusively over the individual upper ends of the edge walls 39, the inner walls 40 and the edge portion 33A of the base portion 33, as shown in FIG. 4, and the edge portions of the righthand lower portion of the plate-shaped portion 31, as shown in FIG. 4. Thus, the shield portion is constituted to prevent the rain water flowing in the passages from flowing into the position, in which the circuit board is arranged, of the housing space 1a.

The not-shown circuit board is arranged in the housing space 1a, as described hereinbefore, and its portion is arranged in the portion of the housing space 1a in the direction joining the upper housing 10 and the lower housing 20, that is, in the portion confronting the terminal exposing through hole 11b and the cast through holes 11a and closer to the lower housing 20 than the holding member 30. The not-shown circuit board is can be charged by connecting the charging/discharging terminals 36 and the signal terminals on the battery side electrically with the charging/discharging terminals 36 and the signal terminals.

When the not-shown battery is to be charged by using the battery charging device 1, one end of the rails disposed on the outer periphery of the not-shown battery is brought into engagement with the upper end of the slide rails 11C of the battery charging device 1, and the battery is slid along the slide rails 11C downward of the sloped face 11A, so that the charging/discharging terminals and the signal terminals of the not-shown battery are brought into contact and electric contact with the charging/discharging terminals 36 and the signal terminals 37 of the battery charging device 1. As a result, the charging operation of the battery is started. The charging/discharging terminals of the not-shown battery correspond to the battery charging terminals.

While the charging operation is performed outdoors at a raining time, the rain water flows into the housing space 1a from the terminal exposing through hole 11b and the cast through holes 11a. The rain water having flown flows downward of the sloped face 11A in the flow passage defined by the upper face 31A of the plate-shaped portion 31, and flows to one portion of the passage, that is, the portions of the grooves 30a defined by the upper face 31A, the edge walls 39 and the inner walls 40 of the plate-shaped portion 31, so that the rain water flows out from the stepped through holes 12a to the outside of the upper housing 10.

The upper housing 10 is equipped with the inlet side opening and the outlet side opening, and the housing space 1a is equipped with the outlet passage forming member for defining the passage for guiding the water having flown from the inlet side opening into the housing space 1a, to the outlet side opening. As a result, the rain water having flown from the inlet side opening of the upper housing 10 into the housing space 1a can be released through the passage of the outlet passage forming member from outlet side opening of the upper housing 10.

This makes it unnecessary to form the passage for the rain water in the portion of the housing space 1a in the direction to join the upper housing 10 and the lower housing 20, that is, in the portion confronting the inlet side opening, but the circuit board and so on can be arranged in that portion so that the housing space 1a can be effectively exploited. Moreover, the not-shown circuit board arranged in the housing space 1a can be waterproofed to make the shielding portion the minimum necessary.

Moreover, the outlet passage forming member is formed of the holding member 30 for holding the terminal block 38. Therefore, the member for supporting the terminal block 38 in the housing space 1a need not be separately provided so that the constitution of the battery charging device can be simplified.

The battery charging device according to the invention should not be limited to the embodiment thus far described, but can be modified and improved in various manners within the range of claims. In this embodiment, for example, the outlet side opening is formed in the upper housing 10, but may also be formed in the lower housing.

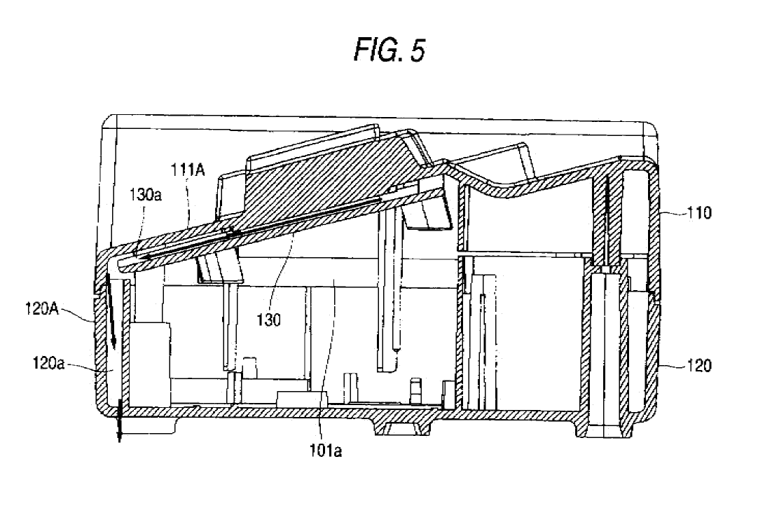

As shown in FIG. 5, more specifically, a lower housing passage 120a is formed along the inner face of the side wall 120A of a lower housing 120 formed generally into a box shape. The lower housing passage 120a extends in the vertical direction of FIG. 5, and has its one lower end opened in the lower end portion of the lower housing 120 and vented to the atmosphere. The other or upper end of the lower housing passage is opened vertically upward in a housing space 101a.

Grooves 130a defining the lower end of the passage of a holding member 130 are formed to extend along the sloped face 111A of an upper housing 110 to the upper end of the lower housing passage 120a, so that the rain water having flown through the grooves 130a flow into the lower housing passage 120a. As a result, the rain water having flown from the not-shown terminal exposing through holes and cast through holes flows, as indicated by arrows of FIG. 5, in the lower housing passage 120a from the upper side to the lower side of FIG. 5, after it flew in the grooves 130a, and is released from the lower end of the lower housing passage 120a to the outside of the outer housing 120.

In the aforementioned modification, moreover, the lower housing need not be formed with the lower housing passage 120a, as shown in FIG. 5. In this case, too, the lower portion of the lower housing has to be formed with a lower through hole for providing the communication between the housing space and the atmosphere. Specifically, the passage has its lower end arranged at a position like that of the lower end of the passage 120a shown in FIG. 5, and the lower through hole is formed generally vertically below the lower end of the passage. The rain water to flow out from the lower end of the passage drops along the inner periphery of the side face of the lower housing so that it is released from the lower through hole to the outside of the lower housing. The lower end of the lower housing passage 120a, as shown in FIG. 5, corresponds to a lower through hole.

Moreover, the shape of the holding member 30 and the shapes of the upper housing 10 and the lower housing 20 are not limited to those of the mode of embodiment. Likewise, the shapes and numbers of the charging/discharging terminals 36 and the signal terminals 37 are not limited to those of the mode of embodiment.

1. A battery charging device comprising:
a lower housing; and
an upper housing defining a housing space together with the lower housing and including at least one inlet side opening having a through hole formed to provide the communication between the housing space and the atmosphere, wherein the housing space is equipped with an outlet passage forming member for defining a passage to guide the water having flown from the inlet side opening into the housing space by attaching the outlet passage forming member to the upper housing.

2. A battery charging device according to claim 1, wherein the upper housing includes at least one outlet side opening having a through hole formed to provide the communication between the housing space and the atmosphere, and
wherein the passage communicates with the outlet side opening.

3. A battery charging device according to claim 2, wherein the passage is sloped downward from the inlet side opening toward the outlet side opening.

4. A battery charging device according to claim 1, wherein the lower housing has its lower portion formed with a lower through hole for providing the communication between the housing space and the atmosphere, and
wherein the passage is constituted to guide the water having flown from the inlet side opening into the housing space, into the lower through hole.

5. A battery charging device according to claim 4, wherein the lower housing has a lower housing passage, one end of which is formed by the lower through hole; and
wherein the passage is constituted to guide the water having flown from the inlet side opening into the housing space, to the other end of the lower housing passage.

6. A battery charging device according to in claim 5, wherein the passage is sloped downward from the inlet side opening toward the other end of the lower housing passage.

7. A battery charging device according to claim 1, wherein the outlet passage forming member includes a holding member for holding a terminal block.

8. A battery charging device according to claim 1, wherein the passage is formed along the upper housing.

9. A battery charging device according to claim 1, wherein the inlet side opening is an opening for exposing charging terminals to the outside of the housing.

10. A battery charging device according to claim 9, wherein the upper housing includes slide rails for sliding a battery in the upper housing to guide the battery charging terminals of the battery in a direction to the charging terminals, so that the battery charging terminals may contact with the charging terminals, and
wherein the through hole of the inlet side opening is cast holes for forming the slide rails on the upper housing when the upper housing is formed by a mold.

11. A battery charging device according to claim 2, wherein the outlet passage forming member includes a holding member for holding a terminal block.

12. A battery charging device according to claim 3, wherein the outlet passage forming member includes a holding member for holding a terminal block.

13. A battery charging device according to claim 4, wherein the outlet passage forming member includes a holding member for holding a terminal block.

14. A battery charging device according to claim 5, wherein the outlet passage forming member includes a holding member for holding a terminal block.

15. A battery charging device according to claim 6, wherein the outlet passage forming member includes a holding member for holding a terminal block.
